(19) United States
(12) Patent Application Publication
(10) Pub. No.: US 2004/0010799 A1
(43) Pub. Date: Jan. 15, 2004

(54) Channel control method and apparatus for television having channel reservation function

(75) Inventor: Bong-ki Jang, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/444,082

(22) Filed: May 23, 2003

(30) Foreign Application Priority Data
Jun. 21, 2002 (KR) 2002-34875

(51) Int. Cl. H04N 7/173; G06F 3/00; H04N 5/445; G06F 13/00

(52) U.S. Cl. 725/58; 725/89

(57) ABSTRACT

There are provided a channel control method and apparatus for a TV having a channel reservation function. The TV channel control method includes (a) determining whether reservation instructions for a subsequent program have been received; (b) if it is determined in step (a) that the instructions have been received, extracting and storing predetermined information concerning the subsequent program from electronic program guide (EPG) information; (c) determining whether it is the starting time of the subsequent program using the predetermined information extracted in step (b); and (d) if it is determined in step (c) that it is the starting time of the subsequent program, changing the present channel to the channel for the subsequent program.

This application claims the priority of Korean Patent Application No. 2002-34875, filed on Jun. 21, 2002, in the Korean Intellectual Property Office, the disclosure of which is incorporated herein in its entirety by reference.

### BACKGROUND OF THE INVENTION

1. Field of the Invention

The present invention relates to a television (TV) channel control method and an apparatus, and more particularly, to a channel control method and apparatus for a TV having a channel reservation function, in which a program that a user wishes to watch next can be reserved while the user is watching the present program, and the present channel can be automatically changed to the channel of the reserved program so that the user can watch the reserved program at the correct starting time thereof.

2. Description of the Related Art

As data processing technologies are particularly developing in the field of televisions, broadcasting stations can transmit various kind of additional information, including general information on TV programs, together with video and audio signals, and TV receivers can utilize such additional information in many applications.

In other words, according to the developments of digital data broadcasting systems, large amounts of additional information can be transmitted for users' convenience. Such additional information includes not only general information on TV programs but also information concerning education, games, on-line commercial transactions, etc., and the coverage of the additional information is inclined to increase.

Usually, a digital TV adopts provides a guide to available programs using additional information called electronic program guide (EPG) information.

Although the interface of a conventional EPG menu system is very complex and inconvenient to use when a user of a digital TV wishes to reserve a desired program using the EPG information through a so called EPG menu system, an alternative system for simply and conveniently reserving the program has not been developed. In particular, since it is not possible to know the correct starting time of the broadcasting of a program reserved through the conventional EPG menu system, the user is forced to watch unwanted advertisement programs or waste time until broadcasting of the reserved program starts.

### SUMMARY OF THE INVENTION

The present invention provides a channel control method and apparatus for a TV having a channel reservation function, in which a program that a user wishes to watch next can be reserved while the user is watching the present program and the present channel can be automatically changed to the channel of the reserved program at the correct starting time thereof.

According to an exemplary aspect of the present invention, there is provided a TV channel control method including the steps of (a) determining whether reservation instructions for a subsequent program have been received; (b) if it is determined in step (a) that the reservation instructions have been received, extracting and storing predetermined information concerning the subsequent program from electronic program guide (EPG) information; (c) determining whether it is the starting time of the subsequent program using the predetermined information extracted in step (b); and (d) if it is determined in step (c) that it is the starting time of the subsequent program, changing the present channel to the channel of the subsequent program.

According to another exemplary aspect of the present invention, there is provided a TV channel control method including the steps of (a) determining whether a predetermined instant reservation menu key value has been received; (b) if it is determined in step (a) that the predetermined instant reservation menu key value has been received, displaying a program reservation menu for displaying available programs and allowing a user to selectively make a reservation for a subsequent program through an on-line display window; (c) if a subsequent program is selected through the program reservation menu, extracting and storing predetermined information concerning the subsequent program from the electronic program guide (EPG) information; (d) determining whether it is the starting time of the subsequent program using the predetermined information extracted in step (c); and (e) if it is determined in step (d) that it is the starting time of the subsequent program, changing the present channel to the channel of the subsequent program.

According to still another exemplary aspect of the present invention, there is provided a TV channel control apparatus including a broadcasting signal receiving unit for selecting and demodulating only such broadcasting signals that correspond to a selected channel from received broadcasting signals in accordance with a channel control signal; an EPG storing unit for storing electronic program guide (EPG) information included in the broadcasting signals received through the broadcasting signal receiving unit; a memory for storing information concerning a subsequent program; a timer circuit for setting up the present time in accordance with a time control signal and producing information on the present time by counting and calculating predetermined clocks; and a controller for carrying out the processes of (a) extracting predetermined information concerning the subsequent program from the electronic program guide (EPG) information when a predetermined program reservation key value for the subsequent program is received and storing the extracted predetermined information in the memory; (b) generating a time control signal for setting the present time of the timer circuit based on the information on the present time, which is transmitted from a broadcasting station corresponding to the selected channel; and (c) comparing the starting time of the subsequent program, which is extracted from the predetermined information stored in the memory, with the present time set in accordance with the time control signal generated from the timer circuit, and if correspondence between the starting time and the present time is detected, generating a channel control signal to change the present channel to the channel of the subsequent program.

According to yet another exemplary aspect of the present invention, there is provided a TV channel control apparatus including a broadcasting signal receiving unit for selecting and demodulating only such broadcasting signals that correspond to a selected channel from received broadcasting signals in accordance with a channel control signal; an EPG storing unit for storing electronic program guide (EPG) information included in the broadcasting signals received through the broadcasting signal receiving unit; a memory for storing information concerning a subsequent program; a timer circuit for setting up the present time in accordance with a time control signal and producing information on the present time by counting and calculating predetermined clocks; a graphic processing unit for producing predetermined graphic signals through an on-screen display window in accordance with a graphic control signal; and a controller for carrying out the processes of (a) generating a graphic control signal to produce a program reservation menu for displaying available programs and allowing a user to selectively reserve the subsequent program when a predetermined instant reservation menu key value is received; (b) extracting predetermined information concerning the subsequent program from the electronic program guide (EPG) information when the subsequent program is selected through the program reservation menu and storing the extracted predetermined information in the memory; (c) generating a time control signal for setting the present time of the timer circuit based on the information on the present time, which is transmitted from a broadcasting station corresponding to the selected channel; and (d) comparing the starting time of the subsequent program, which is extracted from the predetermined information stored in the memory, with the present time set in accordance with the time control signal generated from the timer circuit, and if correspondence between the starting time and the present time is detected, generating a channel control signal to change the present channel to the channel of the subsequent program.

### BRIEF DESCRIPTION OF THE DRAWINGS

The above exemplary aspects and advantages of the present invention will become more apparent by describing in detail illustrative, non-limiting embodiments thereof with reference to the attached drawings in which:

FIG. 1 is a block diagram of a television channel control apparatus according to the present invention;

FIG. 2 is a flowchart of a television channel control method according to an illustrative, non-limiting embodiment of the present invention; and

FIG. 3 is a flowchart of a television channel control method according to another illustrative, non-limiting embodiment of the present invention.

### DETAILED DESCRIPTION OF THE INVENTION

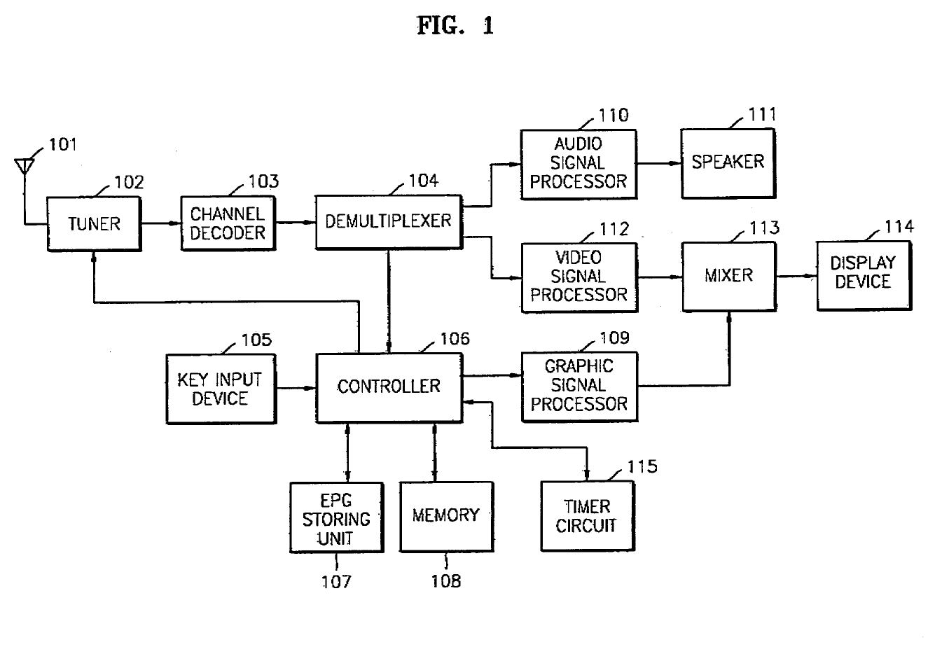

Referring to FIG. 1, a television (TV) channel control apparatus according to the present invention includes an antenna 101, a tuner 102, a channel decoder 103, a demultiplexer 104, a key input device 105, a controller 106, an EPG storing unit 107, a memory 108, a graphic signal processor 109, an audio signal processor 110, a speaker 111, a video signal processor 112, a mixer 113, a display device 114, and a timer circuit 115.

First, basic operations of the TV channel control apparatus shown in FIG. 1 will be described.

When a TV is powered on and a channel is selected using keys of the key input device 105, the tuner 102 receives a channel control signal from the controller 106 and, in accordance with the channel control signal, selects such broadcasting signals that correspond to the selected channel from broadcasting signals received through the antenna 101. The selected broadcasting signals are output to the channel decoder 103. Then, the channel decoder 103 recovers digital signals detected from the selected broadcasting signals in the unit of packets and outputs the recovered digital broadcasting signals to the demultiplexer 104. The demultiplexer 104 separates audio data, video data, and additional information data from the recovered digital broadcasting signals and outputs the separated audio, video, and additional information data in different bit streams.

The separated audio data is decoded and converted to analog signals via the audio signal processor 110, and the converted analog audio signals are ultimately output through the speaker 111.

Meanwhile, the separated video data is decoded and is subject to signal processing, such as error corrections, via the video signal processor 112. The decoded video data is mixed into graphic signals to be displayed on an on-screen display window via the mixer 113, and the mixed signals are ultimately output via the display device 114.

The additional information data separated through the demultiplexer 104 includes electronic program guide (EPG) information. The EPG information is input to the controller 106 and is processed by the controller 106 as follows.

First, the controller 106 updates existing EPG information stored in EPG storing unit 107 with new EPG information included in the currently received additional information.

Then, the controller 106 carries out the following control processes, according to an illustrative, non-limiting embodiment of the present invention.

i) When a next program reservation key value is received from the key input device 105, the controller 106 carries out a first process for reading information on a starting time and a title of a subsequent program from an event information table (EIT) of the currently selected channel, which is included in the EPG information stored in the EPG storing unit 107, and stores the information on a starting time and a title of a subsequent program in the memory 108.

ii) Then, the controller 106 carries out a second process for generating a time control signal to set the time of the timer circuit 115 based on information on the present time, which is transmitted from a broadcasting station corresponding to the currently selected channel.

iii) Thereafter, the controller 106 carries out a third process for comparing a starting time of a subsequent program, which is stored in the memory 108, with the present time produced from the timer circuit 108, and if a correspondence between the starting time and the present time is detected, generating a channel control signal to change the currently selected channel to the channel for the subsequent program through the tuner 102. As the result of the third process, the channel selected through the tuner 102 is changed to the channel for the subsequent program.

The controller 106 may carry out the following control processes, according to another illustrative, non-limiting embodiment of the present invention.

i) When an instant reservation menu key value is received from the key input device 105, the controller 106 carries out a first process for generating a graphic control signal to produce a program reservation menu for listing available programs and allowing a user to selectively reserve a subsequent program based on the EPG information stored in the EPG storing unit 107, and applying the graphic control signal to the graphic signal processor 109. As a result of the first process, the graphic signal processor 109 graphically processes the program reservation menu and outputs the graphically processed program reservation menu to the mixer 113. Then, a picture for the graphically processed program reservation menu is output via the display device 114 to be overlapped with a broadcasting picture output from the video signal processor 112 by way of the mixer 113 or to be displayed in an on-screen display window.

ii) When a reservation for a program is made using the program reservation menu displayed on a screen, the controller 106 carries out a second process for reading information on a starting time and a title of the subsequent program from the event information table (EIT) of the currently selected channel, which is included in the EPG information stored in the EPG storing unit 107, and stores the information on a starting time and a title of the subsequent program in the memory 108.

iii) Then, the controller 106 carries out a third process for generating a time control signal to set the time of the timer circuit 115 based on information on the present time, which is transmitted from a broadcasting station corresponding to the currently selected channel.

iv) Thereafter, the controller 106 carries out a fourth process for comparing a starting time of a subsequent program, which is stored in the memory 108, with the present time produced from the timer circuit 115, and if a correspondence between the starting time and the present time is detected, generating a channel control signal to change the currently selected channel to the channel for the subsequent program via the tuner 102. As a result of the fourth process, the channel selected via the tuner 102 is changed to the channel for the subsequent program.

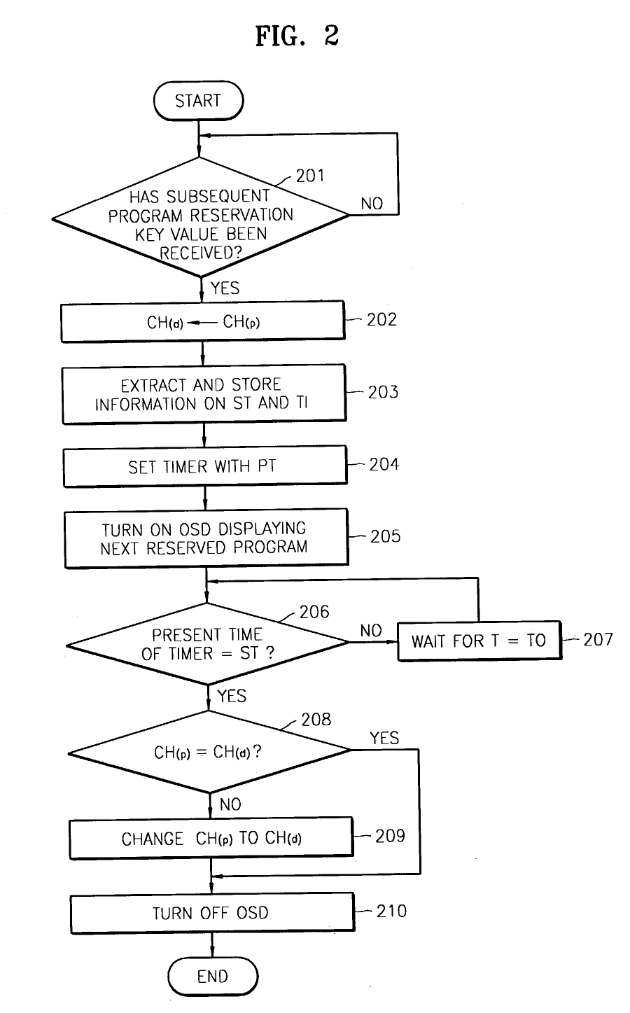

Now, a TV channel control method according to an illustrative, non-limiting embodiment of the present invention will be described with reference to FIG. 2 together with FIG. 1.

It is determined whether a program reservation key value for a subsequent program has been received from the key input device 105 at the controller 106 (STEP 201).

If it is determined in STEP 201 that the program reservation key value for a subsequent program has been received, information on the present broadcasting channel number CH₍ₚ₎ is updated with the information on a channel number CH_{(d)} for the subsequent program and the updated information on the channel number is stored in the memory 108 (STEP 202).

Then, information on a starting time (ST) and a title (TI) of the subsequent program is extracted from the EPG information stored in the EPG storing unit 107, and the extracted information is stored in the memory 108 (STEP 203).

Then, the controller 106 detects information on the present time (PT) of the currently selected broadcasting channel from received additional information, and sets the time of the timer circuit 115 in accordance with the information on the present time (STEP 204).

Then, under the control of the controller 106, a message indicating that a reservation for the subsequent program has been made is displayed in an on-screen display (OSD) window (STEP 205).

After the information on the present time of the timer circuit 115 is stored in the memory 108, the present time is compared with the starting time (ST) of the subsequent program (STEP 206). If the present time and the starting time (ST) are different from each other, a wait mode is enabled for a predetermined time to (STEP 207) and STEP 206 is performed again after the predetermined time to. The predetermined time t₀ is determined, for example, in the unit of seconds.

If it is decided in STEP 206 that the present time of the timer circuit 115 corresponds to the starting time (ST) for the subsequent program, which is stored in the memory 108, the present broadcasting channel number CH₍ₚ₎ is compared with the channel number CH_{(d)} for the subsequent program, which is stored in the memory 108 (STEP 208).

If it is decided in STEP 208 that the present broadcasting channel number CH₍ₚ₎ is different from the channel number CH_{(d)} for the subsequent program, the present broadcasting channel number CH₍ₚ₎ is changed to the channel number CH_{(d)} for the subsequent program (STEP 209).

However, If it is decided in STEP 208 that the present broadcasting channel number CH₍ₚ₎ corresponds to the channel number CH_{(d)} for the subsequent program, STEP 209 is skipped, and the on-screen display (OSD) mode is turned off (STEP 210).

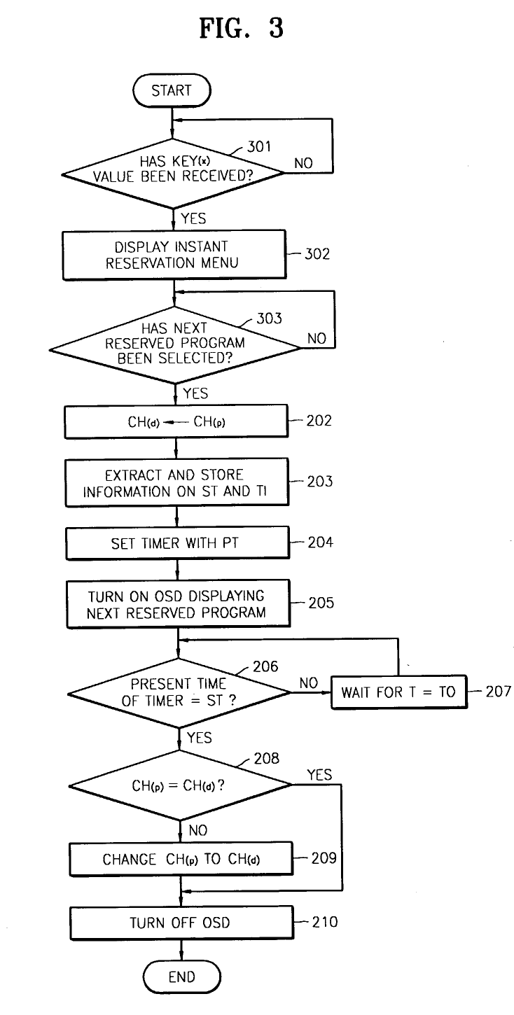

FIG. 3 is a flowchart of a television channel control method according to another illustrative, non-limiting embodiment of the present invention.

First, it is determined whether an instant reservation menu key value KEY₍ₓ₎ has been received from the key input device 105 at the controller 106 (STEP 301). Here, the instant reservation menu is a simplified EPG menu using a portion of the EPG data, rather than a whole EPG menu, to reduce the amount of processing data.

If it is determined in STEP 301 that the instant reservation menu key value KEY₍ₓ₎ has been received, the instant reservation menu is edited and the edited instant reservation menu is displayed in an on-screen display (OSD) window (STEP 302).

After determining whether the subsequent program has been selected via the displayed instant reservation menu in STEP 303, STEPS 202 through 210 are sequentially performed if the subsequent program has been reserved.

Since STEPS 202 through 210 in FIG. 3 are identical to the STEPS 202 through 210, detailed descriptions thereon will be omitted.

As described above, according to the present invention, a subsequent program can be reserved without using the conventional complex EPG menu while a user is watching the present program, and the present channel can be automatically changed to the channel of the subsequent program at the correct starting time thereof. Accordingly, a TV channel control apparatus and method have the following exemplary advantages. First, it is possible to simply and conveniently reserve a program that a user wishes to watch without using the conventional complex EPG menu. Second, since the time of a timer circuit included in a TV is set in correspondence with information on the broadcasting time transmitted from a broadcasting station, it is possible to watch the reserved program from the correct starting time thereof. Third, since it is possible to watch the reserved program from the correct starting time thereof, watching unwanted advertisement programs or unnecessarily waiting for the reserved program can be avoided.

The present invention can be implemented on a recording medium with a code that is readable by a computer. The recording medium that can be read by a computer may include any kind of recording device in which data that is readable by the computer is stored. Non-limiting examples of the recording medium include ROM, RAM, CD-ROM, magnetic tape, hard discs, floppy discs, flash memory, optical data storage devices, and even carrier waves, for example, transmission over the Internet. Moreover, the recording medium may be distributed among computer systems that are interconnected through a network, and the present invention may be stored and implemented as a code in the distributed system.

The present invention has been particularly shown and described with reference to illustrative, non-limiting embodiments thereof, and it will be understood by those of ordinary skill in the art that various changes in form and details may be made therein without departing from the spirit and scope of the present invention as defined by the appended claims.

What is claimed is:

1. A television (TV) channel control method, comprising the steps of:
(a) determining whether a subsequent program reservation instruction has been received;
(b) if it is determined in step (a) that the subsequent program reservation instruction has been received, extracting and storing predetermined information concerning the subsequent program from electronic program guide (EPG) information;
(c) determining whether it is a starting time of the subsequent program using the predetermined information extracted in step (b); and
(d) if it is determined in step (c) that it is the starting time of the subsequent program, changing a present channel to a channel of the subsequent program.

2. The TV channel control method of claim 1, wherein the predetermined information includes information on the starting time of the subsequent program.

3. The TV channel control method of claim 2, wherein the predetermined information further includes information on a title of the subsequent program.

4. The TV channel control method of claim 1, wherein discrimination of the starting time of the subsequent program is carried out by setting the time of a timer circuit based on information on a present time, which is transmitted from a broadcasting station related to the subsequent program, and comparing the time of the timer circuit and the starting time of the subsequent program.

5. The TV channel control method of claim 1, further comprising the steps of:
when a subsequent program reservation instruction has been received, generating a message indicating that the subsequent program has been reserved; and
displaying the message through an on-screen display window until the subsequent program starts.

6. A television (TV) channel control method, comprising the steps of:
(a) determining whether a predetermined instant reservation menu key value has been received;
(b) if it is determined in step (a) that the predetermined instant reservation menu key value has been received, displaying a program reservation menu for displaying available programs and allowing a user to selectively reserve a subsequent program via an on-screen display window;
(c) if the subsequent program is selected through the program reservation menu, extracting and storing predetermined information concerning the subsequent program from electronic program guide (EPG) information;
(d) determining whether it is a starting time of the subsequent program using the predetermined information extracted in step (c); and
(e) if it is determined in step (d) that it is the starting time of the subsequent program, changing a present channel to a channel of the subsequent program.

7. The TV channel control method of claim 6, wherein the predetermined information includes information on the starting time of the subsequent program.

8. The TV channel control method of claim 7, wherein the predetermined information further includes information on a title of the subsequent program.

9. The TV channel control method of claim 6, wherein discrimination of the starting time of the subsequent program in step (d) is carried out by setting the time of a timer circuit based on information on a present time, which is transmitted from a broadcasting station related to the subsequent program, and comparing the time of the timer circuit and the starting time of the subsequent program.

10. The TV channel control method of claim 6, further comprising the steps of:
when a subsequent program reservation instruction has been received, generating a message for indicating that the subsequent program has been reserved; and
displaying the message via an on-screen display window until the subsequent program starts in accordance with the subsequent program reservation instruction.

11. A television (TV) channel control apparatus, comprising:
a broadcasting signal receiving unit selecting and demodulating, from a plurality of received broadcasting signals, only those broadcasting signals that correspond to a selected channel in accordance with a channel control signal;
an EPG storing unit storing electronic program guide (EPG) information included in the broadcasting signals received through the broadcasting signal receiving unit;
a memory storing information concerning a subsequent program;
a timer circuit setting a present time in accordance with a time control signal and producing information on the present time by counting and calculating predetermined clocks; and
a controller carrying out the processes of (a) extracting predetermined information concerning the subsequent program from the electronic program guide (EPG) information when a predetermined program reservation key value for the subsequent program is received and storing the extracted predetermined information in the memory, (b) generating the time control signal for setting the present time of the timer circuit based on information on the present time that is transmitted from a broadcasting station corresponding to the selected channel, and (c) comparing a starting time of the subsequent program, which is extracted from the predetermined information stored in the memory, with the present time generated from the timer circuit, and if correspondence between the starting time and the present time is detected, generating a channel control signal to change a present channel to a channel for the subsequent program.

12. The TV channel control apparatus of claim 11, further comprising a graphic processing unit displaying, when a subsequent program reservation instruction has been received, a message, which indicates that the subsequent program has been reserved, via an on-screen display until the subsequent program starts in accordance with the subsequent program reservation instruction.

13. A television (TV) channel control apparatus, comprising:
a broadcasting signal receiving unit selecting and demodulating, from a plurality of received broadcasting signals, only those broadcasting signals that correspond to a selected channel in accordance with a channel control signal;
an EPG storing unit storing electronic program guide (EPG) information included in the broadcasting signals received through the broadcasting signal receiving unit;
a memory storing information concerning a subsequent program;
a timer circuit setting a present time in accordance with a time control signal and producing information on the present time by counting and calculating predetermined clocks;
a graphic processing unit producing predetermined graphic signals in an on-screen display window in accordance with a graphic control signal; and
a controller carrying out the processes of (a) generating the graphic control signal to produce a program reservation menu for displaying available programs and allowing a user to selectively reserve a subsequent program when a predetermined instant reservation menu key value has been received; (b) extracting predetermined information concerning the subsequent program from the electronic program guide (EPG) information when the subsequent program is selected through the program reservation menu and storing the extracted predetermined information in the memory; (c) generating the time control signal for setting the present time of the timer circuit based on the information on the present time, which is transmitted from a broadcasting station corresponding to the selected channel; and (d) comparing a starting time of the subsequent program, which is extracted from the predetermined information stored in the memory, with the present time generated from the timer circuit, and if correspondence between the starting time and the present time is detected, generating a channel control signal to change a present channel to a channel for the subsequent program.

14. The TV channel control apparatus of claim 13, wherein the graphic processing unit displays, when a subsequent program reservation instruction has been received, a message, which indicates that the reservation of the subsequent program has been made, via an on-screen display window until the subsequent program starts in accordance with the reservation instruction.
